(19) United States
(12) Patent Application Publication
(10) Pub. No.: US 2013/0043091 A1
(43) Pub. Date: Feb. 21, 2013

(54) CONSTRAINED LAYER DAMPING MATERIAL AND SYSTEM

(71) Applicant: Maurice E. Wheeler, Mentor, OH (US)

(72) Inventor: Maurice E. Wheeler, Mentor, OH (US)

(73) Assignee: INTELLECTUAL PROPERTY HOLDINGS, LLC, Cleveland, OH (US)

(21) Appl. No.: 13/211,543

(22) Filed: Aug. 17, 2011

(51) Int. Cl. E04B 1/84; C09K 3/00

(52) U.S. Cl. 181/294; 252/62

(57) ABSTRACT

A damping composition for a vibrational damping layer is provided, including about 5 to about 40 weight percent butyl rubber and about 4 to about 12 weight percent ethylene copolymer. In one embodiment, the damping composition can include about 10 to about 30 weight percent butyl rubber, about 4 to about 12 weight percent ethylene vinyl acetate about 10 to about 40 weight percent filler, about 5 to about 15 weight percent plasticizer, about 2 to about 30 weight percent tackifier, and about 1 to about 10 weight percent adhesion promoter. A damping system is also provided, including a base blank, a constraining layer, and a damping layer, wherein the damping layer comprises from about 5 to about 40 weight percent of a butyl rubber, and is in contact with and positioned in between the base blank and the constraining layer.

### FIELD OF THE INVENTION

The invention relates to constrained layer damping systems and damping layer compositions and, more particularly, to constrained layer vibration damping systems and damping layer compositions including a vibrational damping butyl rubber mastic material.

### BACKGROUND

It is a goal in the automotive industry to reduce and minimize the amount of noise, vibration and harness (NVH) levels in the passenger compartment. Rotating transmission and axle linkages, high-speed and/or high-shear moving parts, rotating bearings and rotating tires contacting the road all create structural vibration and noise. Collectively, this vibration and noise can create uncomfortable conditions for the passengers. It is desirable to reduce the amount of noise and vibration that enters the passenger cabin to improve the comfort of the passengers.

It is known to use constrained layer damping structures and materials to reduce the vibration of the automobile body panels and thereby reduce the noise produced by the automobile. Several different damping systems can be used, including those known as peel and stick, spray-on, constrained layer damping, and full panel damping. However, there are several drawbacks that plague these systems, such as, difficulties in ensuring proper location of the damping system, application of improper quantities of damping material, high cost of installation, unwanted gaps between layers, delamination of layers after formation, stamping, or baking and increased material costs and weight. Thus, there is a need for more effective damping systems having improved or more effective vibration damping materials which provide increased stiffness, reduced sound transmission, stress absorption of stamping or formation processes and are more cost effective to manufacture.

### SUMMARY

A damping composition for a vibrational damping layer is provided, which includes from about 5 to about 40 weight percent butyl rubber and about 4 to about 12 weight percent ethylene copolymer.

A damping composition for a vibrational damping layer is provided, which includes from about 5 to about 40 weight percent butyl rubber, from about 4 to about 12 weight percent of ethylene vinyl acetate, from about 10 to about 50 weight percent filler, from about 5 to about 20 weight percent plasticizer, from about 2 to about 30 weight percent tackifier, and from about 1 to about 10 weight percent wetting agent.

A damping system is also provided, including a base blank, a constraining layer, and a damping layer, wherein the damping layer includes from about 5 to about 40 weight percent butyl rubber, and is in contact with and positioned in between the base blank and the constraining layer.

### BRIEF DESCRIPTION OF THE DRAWINGS

FIG. 1 shows a schematic, cross-sectional view of a constrained layer damping system.

FIG. 2 shows an expanded cross-sectional view of a constrained layer damping system of FIG. 1.

FIG. 3 shows an overhead view of a base blank having multiple separate constrained/damping constructs placed in varying positions on the base blank.

### DETAILED DESCRIPTION

As used herein, parts are parts by weight and percentages are weight percents unless otherwise indicated or apparent. When a preferred range such as 5-25 is given, this means preferably at least 5 and, separately and independently preferably not more than 25. As used herein, a vehicle can include, but is not limited to, a car, truck, all-terrain vehicle, tractor, mower, etc. As used herein, the vehicle body part can include, but is not limited to, a car door panel, dashboard panel, wheel hub panel, floor panel, hood panel, support brace or beam, etc.

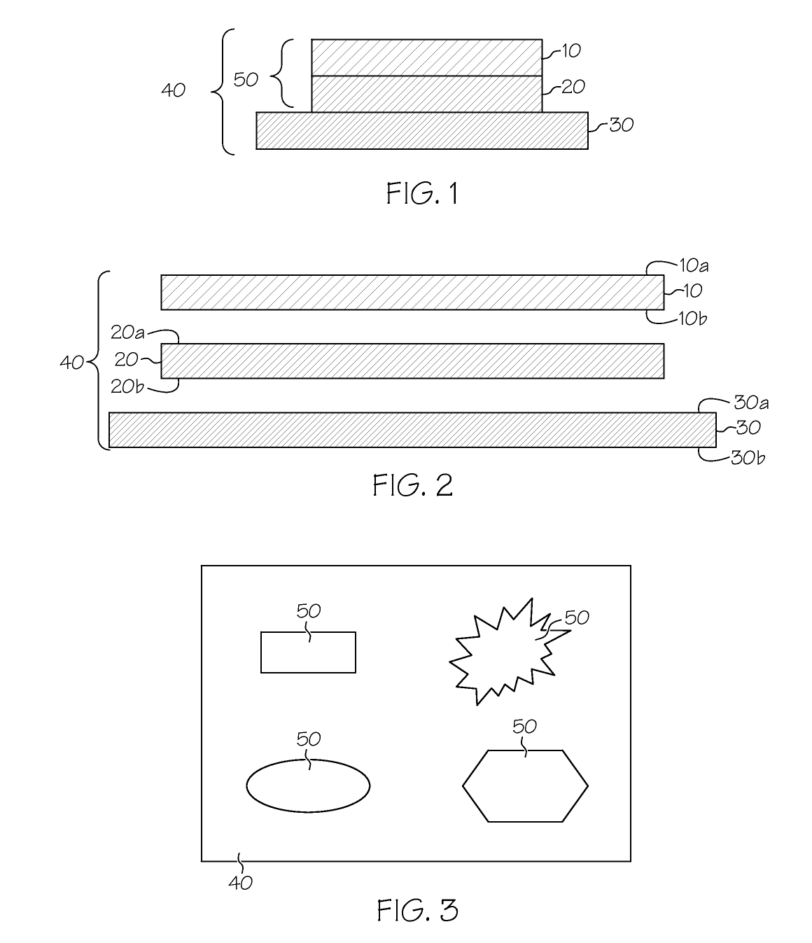

With reference to FIG. 1 there is shown schematically a constrained layer damping system 40 having a base blank 30 to be damped, such as a metal automobile body panel, a butyl rubber-based vibration damping layer 20 according to the compositions disclosed herein, and a constraining layer 10. The base blank 30 to be damped is or can be a vehicle body panel (or any other panel) that otherwise suffers from or experiences vibration. The damping composition of the damping layer 20 is preferably a butyl rubber-based mastic adhered to or disposed between the base blank 30 that is to be damped, and the constraining layer 10.

With reference to FIG. 2, the components of the damping system 40 prior to being adhered or assembled together are shown. The system 40 has a damping layer 20, a base blank 30 and a constraining layer 10 as shown. In one embodiment, the damping layer 20, preferably in liquid form, is applied directly to and in contact with the bottom surface 10b of the constraining layer 10. The damping layer is thus formed integrally on and adhered to the surface 10b of the constraining layer 10. The contact between the constraining layer 10, such as the bottom or top face 10a, 10b, and damping layer 20 is preferably continuous and uninterrupted with no interfacial layer or adhesive material separating the two layers 10, 20, either entirely or a select portion thereof. Once the damping layer 20 is applied to a surface of the constraining layer 10, the top surface 30a of the base blank 30 is brought into contact with the damping layer 20, which is in contact with the constraining layer 10, to form the damping system 40.

Alternatively, the damping layer 20 can be applied directly to the top surface 30a of the base blank 30 in a manner that the layer 20 is formed integrally on and adhered to the surface 30a. The constraining layer 10 is further brought into contact with the opposing surface of the damping layer 20, for example, 20a as shown in FIG. 2. In this embodiment, the layer 20 is also preferably formed integrally to and adhered to the bottom surface 10b of the constraining layer 10. There is preferably no interfacial layer or adhesive material between the damping layer 20 and the base blank 30 or constraining layer 10.

With reference to dimensions, in one embodiment, the constraining layer 10 has a smaller size than the underlying base blank 30 in terms of lateral dimensions. Herein, ‘lateral dimension’ refers to a dimension along the surface expanse of a layer or substrate, which can be planar or follow a curved surface contour whose tangent is generally orthogonal to the thickness dimension at any given point in the layer or substrate. The ratio of the constraining layer 10 surface area to the base blank 30 surface area can be 0.05 to 0.9.

The base blank 30 can be a steel (preferably cold rolled steel, or “CRS”), which may optionally include a protective coating which is effective at inhibiting rust. As described herein, a coating, such as a protective coating, on the base blank 30 is considered an integral part of the base blank 30 such that application of the damping layer 20 on a surface of the base blank 30 can also include application of the damping layer 20 on such a protective coating. The base blank 30 may also be made from other ferrous materials such as stainless steel, tin-free steel or coated steel. Additionally, the base blank 30 may be made from other metallic non-ferrous materials such as aluminum or other rigid, non-metallic materials such as polyethylene, polypropylene, PET, polystyrene, cardboard, wood, or any other rigid material. A ‘blank’ is defined as a piece that has not been stamped (i.e. pre-stamped) or formed into the final desired shape or contour for the finished part, such as an vehicle body part. The base blank 30 can be about 0.026 to 0.035 inches thick, and less preferably 0.005 to 0.100 inches thick. The base blank 30 preferably can have a uniform thickness or, in the alternative, it can be a laser welded blank having varying materials of varying thickness welded together to form a primary layer to be used as the base blank 30. In one embodiment, the blank 30 can be a rectangular sheet. In another embodiment, the blank can be engineered so that it has a more complex shape than a rectangle and can be dimpled, rippled, corrugated, smooth, or have other surface textures or dimensions. In one embodiment, the base blank 30 is made from a vehicle body part blank of any shape or contour as may be desired, such as a dashboard panel or wheel well blank. In yet another embodiment, the base blank 30 to be damped is a body panel of an automobile and may optionally include through holes, such as a dashboard panel with an opening to accommodate a steering column or a wheel well panel containing an opening for an axle rod. The opening in the base blank 30 can be any shape or size that may be desirable. The appropriate damping system 40 is provided by assembling the damping layer 20 and constraining layer 10 mentioned above at the desired location on the surface of the base blank 30.

The constraining layer 10 can be the same material as the base blank 30 or can be a different material. The constraining layer 10 can be a steel sheet, such as CRS, and may optionally include a protective coating which is effective at inhibiting rust. As described herein, a coating, such as a protective coating, on the constraining layer 10 is considered an integral part of the layer 10 such that application of the damping layer 20 on a surface of the layer 10 can also include application of the damping layer 20 on such a protective coating. The layer 10 may also be made from other ferrous materials such as stainless steel or tin-free steel. Additionally, the constraining layer 10 may be made from other metallic non-ferrous materials such as aluminum or other rigid, non-metallic materials such as polyethylene, polypropylene, cardboard, wood, or any other rigid material. With respect to thickness, the constraining layer 10 can be the same thickness as the base blank 30 or can differ. The layer can have a thickness from about 0.026 to 0.035 inches, and less preferably 0.005 to 0.100 inches. In one embodiment, the constraining layer 10 can have a uniform thickness and, in another embodiment, it can be a laser blank having varying thickness.

The initial form or shape of the constraining layer 10 can affect properties such as, for example the stiffness of the damping system 40 or the ability of the system to dampen various resonant frequencies for noise reduction, such as low frequency noise reduction. As such, the constraining layer 10 may be in any initial form prior to application, for example, to the damping layer 20. For instance, the constrained layer 10 can be dimpled, rippled, corrugated or smooth. The constraining layer 10 may be in any shape or, for example, have through holes for clearance in installment, such as in alignment with an aperture or through hole in the base blank 30 (not shown).

The damping composition of the damping layer 20 is preferably an uncured, butyl rubber mastic composition made from a copolymer of isobutylene and isoprene, which can be halogenated with a halogen such as chlorine or bromine to produce the butyl rubber or halobutyl. In one embodiment, the damping composition is substantially free of a curing agent, and more preferably no curing agent is present in the damping composition. In another embodiment, the damping composition is substantially free of a curing agent and an acceleration agent used for curing compositions as known in the art, and more preferably no curing agent and acceleration agent are present in the damping composition. As described herein, substantially free of a curing agent or acceleration agent relates to the overall structural make up of the damping composition being flowable such that no cross-linking is present that would cause appreciable hardening of the composition and delamination of the damping system 40. For example, the damping composition preferably contains no curing agent and/or acceleration agent, or less than 0.1, 0.25, 0.5, 1 or 5 weight percent of either a curing agent or acceleration agent. As will be seen below, the damping layer 20 can be made from several components.

The use of butyl rubber in the damping system 40 allows the damping layer 20 to remain flexible and flowable when the system 40 is being formed or stamped into a final shape or product such that the stresses imparted during the stamping or forming process do not cause the structural composition of the damping layer 20 to become deformed. The forming or stamping process introduces large stresses and deformation in both the base blank 30 and the damping layer 20. In many damping systems, the damping material will break down, for example cross-linking can become compromised, as a result of the stress and structural deformations associated with the forming process. Damping materials can also suffer from high residual stress as a result of the forming process and can be stretched during formation wherein the damping material can then subsequently shrink when the stamping or formation process is completed. Such stresses can cause the damping material to delaminate from the base layer or shrink from its intended size. When the damping material breaks down, delaminates, or changes in size, its damping effectiveness and long term stability are decreased. As noted above, the use of butyl rubber substantially eliminates the deformation or shrinkage that is typically associated with the forming process.

More specifically, the composition of the damping layer 20 does not require the use of a curing agent and/or acceleration agent and is not cured during the assembly and forming of the damping system 40. Because the damping layer 20 is not cured, it remains in an amorphous or uncured and flowable state during the forming process. This uncured state allows the damping layer 20 to flow while being subjected to the stress and deformation associated with the process. Thus, the resultant shrinkage and loss of adhesion associated with other polymer damping materials is substantially reduced or eliminated in the uncured composition of the damping layer 20 described herein.

Suitable commercial butyl rubbers for use in the damping layer 20 can include, but are not limited to, Exxon Butyl 268, Exxon Chlorobutyl 1066 and Bromobutyl 2222, combinations thereof and the like. Other commercially available butyl rubbers can also be used. Exxon Chlorobutyl 1066 and Bromobutyl 2222 are halobutyls derived from reacting butyl rubber with chlorine and bromine, respectively. In one example, the damping layer 20 can include a combination of butyl rubbers, such as an unhalogenated butyl rubber, Exxon Butyl 268, in combination with a halobutyl, Exxon Chlorobutyl 1066 or Bromobutyl 2222. One or more butyl rubbers can be used in the damping layer 20 in the range from about 5 to about 40 weight percent, preferably from about 10 to about 30 weight percent, and preferably about 20 weight percent, or for example, about 18, 19, 20, 21 or 22 weight percent of the damping layer 20. Suitable butyl rubbers for use in the damping layer 20 can have a Mooney viscosity in the range of 30 to 60, or about 30, 35, 40, 45, 50, 55. The Mooney viscosity is measured according to ASTM D 1646, MV 2000, or equivalent thereof.

The damping layer 20 may include one or more ethylene copolymers, such as ethylene vinyl acetate (EVA). The copolymer is preferably stress-crack resistant, heat resistant and possesses physical characteristics that approach elastomeric materials in softness and flexibility. Preferably, the damping layer 20 can include one or more EVAs. More preferably, the damping layer can include two or more EVAs, and more preferably still, one of the EVAs is acid modified. EVA components that can be used include those with vinyl acetate (VA) weight percentages between 10 and 40, preferably 15 to 30. One or more EVAs can be used in a range from about 1 to about 20 weight percent, preferably from about 4 to about 12 weight percent, or for example, 6, 7, 8 or 9 weight percent of the damping layer 20. Alternatively, ethylene copolymers such as ethyl methyl acrylate (EMA), ethylene acrylate acid (EAA), and ethylene ethyl acrylate (EEA) can be used.

In one embodiment, the ethylene copolymer component of the damping layer 20 can include two or more EVA materials of varying weight percents and having varying amounts of VA loading. The first EVA material can have a VA loading in the range of about 20 to about 30 weight percent of the first EVA material, or for example, about 25 weight percent. The first EVA material can be present in the damping layer 20 in the range of about 2 to about 6 weight percent, or for example, about 3, 4 or 5 weight percent. The first EVA material can also be acid modified. One example of a suitable first EVA material is Elvax 4310 supplied by Dupont, an acid-modified EVA with a VA loading of 25 weight percent and a melt index of about 500 g/10 min. The second EVA material can have a VA loading in the range of about 15 to about 25 weight percent of the second EVA material, preferably about 15 to about 20 weight percent, or for example, about 16, 17, 18 or 19 weight percent. The second EVA material can be present in the damping layer 20 in the range of 2 to about 6 weight percent, or for example, about 3, 4 or 5 weight percent. On example of a suitable second EVA material Excorene Ultra LD-720 supplied by Exxon. Overall the ethylene copolymer component can be in the range of about 4 to about 12 weight percent, preferably about 6 to about 10 weight percent, or for example, about 7, 8, or 9 weight percent of the damping layer 20.

The damping layer 20 can further include additives such as, for example, but not limited to, plasticizers, filler components, tackifiers, adhesion promoters, colorants, or combinations thereof. Each type of additive is described below.

A plasticizer can be used to modify the glass transition temperature (T_{g}) and/or modify the viscosity of the damping layer 20. Plasticizers suitable for use with the butyl rubber and thermoplastic resin components can include, but are not limited to, polybutene plasticizers such as Indopol H1500 supplied by INEOS Oligomers. Any other plasticizer or a combination of plasticizers can be used. One or more plasticizers can be used in a range from about 5 to about 20 weight percent, and preferably from about 8 to about 15 weight percent, or for example, about 11 or 12 weight percent of the damping layer 20.

The filler component can be selected from a number of organic or inorganic materials. One example of an inorganic filler is #60 Dolomite as supplied by National Lime and Stone Company, which includes both calcium carbonate and magnesium carbonate as principal components. Another example is Mistron Vapor R as supplied by Rio Tinto Minerals, a reinforcing filler that can also act as a processing aid in rubber applications. An example of an organic filler is cellulosic fiber, such as Arbocel 185 supplied by J. Rettenmaier USA LP. Alternatively, other organic or inorganic fillers may be used including, but not limited to, calcium carbonate, limestone, clay, talc, silica or mica, other silicates known in the art and other mineral fillers. One or more fillers can be used in a range from about 10 to about 50 weight percent, preferably from about 20 to about 40 weight percent, preferably about 30 to about 40 weight percent of the damping layer 20.

A tackifier assists the damping layer 20 in adhering to the base blank 30 to be damped, typically an automotive body panel, and to the constraining layer 10. Examples of suitable tackifiers that can be used in the damping layer 20 include, but are not limited to, Wingtack 86, an aromatic petroleum hydrocarbon resin, available from Sartomer and Sylvatac RE-40 available from The Cary Company. One or more tackifiers can be used in a range from about 2 to about 30 weight percent, preferably from about 4 to about 20 weight percent of the damping layer 20. In one embodiment, the tackifier component of the damping layer 20 can include a blend of two or more materials to control viscosity and tack. For example, a blend of two materials of varying weight percents can include a first tackifier such as Wingtack 86 present in the range of about 10 to about 20 weight percent, or for example, about 14, 15, 16, 17 or 18 weight percent of the damping layer 20 and a second tackifier such as Sylvatac RE-40 present in the range of about 2 to about 6 weight percent, or for example, about 3, 4 or 5 weight percent of the damping layer 20.

The damping layer 20 can include a colorant as desired. One example of a colorant is carbon black. Another example is B22237 supplied by Spartech. It is to be understood that other colorants not mentioned may also be used. One or more colorants can be used in a range from about 0.1 to about 5.0 weight percent, or from about 0.1 to about 1.0 weight percent.

An adhesion promoter can be added to the damping layer to assist in making a uniform coating application. One or more adhesion promoters can be added in a range from about 1 to about 10 weight percent, preferably about 7 to 9 weight percent, or for example, about 8 weight percent of the damping layer 20. An example adhesion promoter includes Aclyn 295 supplied by Honeywell. Alternatively, Elvax 4310 can also be used.

Other agents, with the exception of curing agents and acceleration agents, can be added to the damping layer depending on the requirements of the application. The amounts and ranges of the components discussed above, such as butyl rubber, thermoplastic resin, plasticizer, filler and tackifier, permit the formulation of the damping layer 20 to be customized for specific applications accounting for service temperature and a balance of sound-transmission reduction and vibrational-damping properties.

The components for providing the damping layer described herein are combined and mixed in a conventional manner. After mixing, the damping composition can be applied to the constraining layer 10 using a variety of conventional application methods. As discussed above, the constraining layer 10 having the damping layer composition on one side can be applied directly to the surface of the base blank 30 to provide a sandwich structure. The amount of damping composition applied to the either the constraining layer 10 or the base blank 30 should be approximately the amount needed to achieve the desired thickness of the damping layer in order to minimize the amount of scrap. The damping layer is preferably 0.018 to 0.020 inches thick, less preferably 0.015 to 0.025 inches thick, less preferably 0.010 to 0.050 inches thick, and less preferably 0.010 to 0.0850 inches thick.

A method for forming or producing the damping system 40 will now be described. Beginning with the constraining layer 10, a constraining layer 10 is provided having a top 10a and bottom surface 10b, as shown in FIG. 2. The constraining layer 10 can be blanked if desired. Blanking can occur in any conventional manner, for example in a high blanking press at a rate of up to 1000 pieces an hour or more. Blanking the constraining layer 10 can result in a surface area footprint that is smaller than the surface area footprint of the base blank 30. For example, the constraining layer 10 can have a surface area footprint about 90, 80, 70, 60, 50, 40, 30, 20, 10 or less percent of the base blank 30 surface area footprint. The constraining layer 10, perhaps blanked, can be cleansed to remove dirt, grease, and/or residue oils. Cleansing may include one or both sides of the constraining layer 10 and may include wiping the layer clean with a rag, or it may involve more stringent steps such as, for example, a phosphate cleaning system such as the kind commonly used in the automotive industry.

The damping layer 20 is then applied over the bottom surface of the constraining layer 10 to form a constraining/damping construct 50. Preferably, the damping layer is applied over a cleansed surface of the constraining layer 10. As applied, the damping layer is exposed on one side, the other side being in contact with the constraining layer 10. Application may be, for example, by roll coat, extrusion, transfer from release paper, or any other conventional manner. In one embodiment, the damping layer can be coated over the constraining layer 10 using a reverse roll coater. Upon application of the damping layer, the constraining/damping construct 50 is optionally heated. Heating can be done in any conventional manner such as, for example, in an oven, by induction or a heated press.

The constraining/damping construct 50 has a surface area footprint such that the constraining layer 10 and damping layer each have approximately the same surface area footprint. As shown in FIG. 3, the base blank 30 has a larger surface area footprint than that of the multiple constraining/damping constructs overlying the base blank 30. The areas of the base blank 30 having a constraining/damping construct 50 directly overlying are effectively damped by the construct. That is, the constraining/damping construct 50 is applied over the area or areas of the base blank 30 to be damped. Thus, if multiple areas or portions of the base blank 30 require damping, a constraining/damping construct 50 can be applied over each area to be damped on the base blank 30. It is to be appreciated that the method of applying the constraining/damping construct 50 may be performed in varying manners according to the needs of the situation. For example, the base blank 30 may be treated only where necessary or in the vibrational “hot spots”. These “hot spots” would be determined using one or more of the following methods, such as, for example and not limitation, computer simulation, bench top testing, or in-situ testing. Certain areas of the base blank 30 of the constrained layer damping system 40 could be subject to more vibration when in use as the end product and those areas may require more damping than other areas of the base blank 30. Rather than place extra constraining/damping constructs on areas of the base blank 30 that do not require it, the constraining/damping construct 50(s) can be selectively placed in varying positions, as needed. Placing multiple separate constraining/damping constructs onto the blank base only where they are needed will, among other things, help to save on material costs while providing efficient protection.

As with the constraining layer 10, the base blank 30 can be engineered to a specific thickness and shape if desired. After any such blanking step, the base blank 30 can be cleansed in the areas at which a constraining/damping construct 50 will be attached similar to the cleansing of the constraining layer 10. The exposed side of the damping layer on the constraining/damping construct 50 is applied or pressed over a cleansed portion of the base blank 30 to form the damping system 40. The pressing method can be done robotically after which spot welding can be used to ensure proper placement of the constraining/damping construct 50. A pressing station may also be included to assist in adhesion. For example, a Carver press or an equivalent can be used. The pressing pressure used can be dependent of the viscosity of the damping layer and the temperature at which the pressing operation is conducted. The station may also include a temporary mechanical fastening or welding station, wherein the constraining/damping construct 50 can be welded to the base blank 30. Such a station may be needed if robotic means for pressing are not available or as a contingency.

In one embodiment, not shown, the damping system 40 can have one or more through holes for receiving various components, such as those conventionally used in the automotive industry, for example, a rod or steering wheel column. Each layer of the damping system 40, the base blank 30 and damping and constraining layer 10, can have one or more through holes that extend entirely through the upper and lower surfaces of each layer. Each through hole present in the layers of the damping system 40 can be in register with each other to form a continuous through hole for receiving various components.

The resulting damping system 40 then can be cut and/or stamped into desired shapes to suit particular applications such as passenger vehicle body parts by conventional methods such as forming dies. The damping layer discussed herein provides a damping system 40 that is effective to damp vibrations in vehicle body parts, while at the same time, due, in part, to the fact that the damping layer 20 remains substantially uncured, is flexible enough to bend and form to the contour of the body parts when stamped. The continuous surface-to-surface contact between the damping layer and the constraining layer 10 and base blank 30 maximizes the transfer of vibrations from the vibrating body panel (base blank 30) to the damping layer. The damping system 40 provides increased localized stiffness to the vehicle body part at or near the source of the vibration that produces or primarily contributes to the vibration. Furthermore, because there is continuous surface-to-surface contact between all three components of the damping system 40 due to the base blank 30 and constraining layer 10 being formed together and because the damping layer 20 does not expand or shrink appreciably in paint ovens, there are no gapping issues.

The resultant damping system 40 can exhibit a peel adhesion strength (as determined using ASTM D3330) between the damping layer and the base blank 30 and constraining layer 10 that is preferably greater than 10 lbs/in, preferably greater than 15 lbs/in, preferably greater than 20 lbs/in, and preferably greater than 25 lbs/in at a temperature of about 23° C. (±2° C.). Preferably, the damping system 40 effectively dampens vibrations at frequencies below 300 Hz. The damping layer has excellent loss factor and vibrational damping characteristics at low frequencies, such as below 1000 Hz. The damping layer can have a loss factor (as determined using the Oberst Test, SAE J1637) of at least 0.05-0.50, preferably 0.10-0.40, preferably 0.15-0.35 or preferably about 0.20 or 0.3 for a vibration of 200 Hz at 15°, 23°, 30°, 45° or 60° Celsius. The damping layer can exhibit thermal stability up to 300°, preferably 325°, preferably 350°, preferably 400°, or preferably 425° Fahrenheit.

### EXAMPLES

The examples in the following tables further illustrate various aspects of the invention. In the following examples, all composition data are given as weight percents for the specified component based on the total composition for each example. Compositions according to the following examples have been prepared, and their physical and damping characteristics measured, as indicated in the data below.

### Example 1

A damping layer formula and its ingredients can be found in Table 1 below.

TABLE 1

| Ingredient | Formula A |
|---|---|
| Chlorobutyl (Exxon 1066) | 19.5% |
| Arbocel 185 | 12.0% |
| Wingtack 86 | 16.0% |
| Sylvatac RE-40 | 4.5% |
| Elvax 4310 | 4.0% |
| Escorene Ultra LD-720 | 4.0% |
| Aclyn 295 Ionomer | 4.0% |
| Indopol H-1500 | 11.5% |
| Mistron Vapor R | 24.0% |
| B22237 | 0.5% |

Peel adhesion strength at the time of cohesive failure was measured as 26.1 lbs/in at about 25° C. (±2° C.) using the ASTM D3330 test method by clamping the base blank portion of the damping system in a fixed position so as to lock the base blank portion in place and subsequently pulling the constraining layer 10 portion upward at a rate of 12 inches per minute and measuring the force (lbs/in) once the base blank and constraining layer begin to separate.

The vibration damping performance of the composite was measured using the Oberst test (SAE J1637) as known in the art. The Oberst test includes vibrating a cantilevered steel bar having a damping material bonded thereon at a specific frequency and temperature and measuring the damping performance that is expressed in terms of composite loss factor. The loss factor for the above-described damping system was interpolated at 200 Hz at the temperatures shown in table 2.

TABLE 2
Oberst Results (0.030″ steel bar/0.020″ mastic/0.030″ steel bar)

| Temperature | Formula A |
|---|---|
| 15° C. | 0.30 |
| 23° C. | 0.35 |
| 30° C. | 0.46 |
| 45° C. | 0.24 |
| 60° C. | 0.13 |

### Example 2

A damping layer formula and its ingredients can be found in Table 3 below.

TABLE 3

| Ingredient | Formula B |
|---|---|
| Butyl (Exxon 268) | 19.5% |
| Arbocel 185 | 12.0% |
| Wingtack 86 | 16.0% |
| Sylvatac RE-40 | 4.5% |
| Elvax 4310 | 4.0% |
| Escorene Ultra LD-720 | 4.0% |
| Aclyn 295 Ionomer | 4.0% |
| Indopol H-1500 | 11.5% |
| Mistron Vapor R | 24.0% |
| B22237 | 0.5% |

Peel adhesion strength at the time of cohesive failure was measured as 25.4 lbs/in at about 25° C. (±2° C.) using the ASTM D3330 test method by clamping the base blank portion of the damping system in a fixed position so as to lock the base blank portion in place and subsequently pulling the constraining layer portion upward at a rate of 12 inches per minute and measuring the force (lbs/in) once the base blank and constraining layer begin to separate.

The vibration damping performance of the composite was measured using the Oberst test (SAE J1637) as known in the art. The loss factor for the above-described damping system was interpolated at 200 Hz at the temperatures shown in table 4.

TABLE 4
Oberst Results (0.030″ steel bar/0.020″ mastic/0.030″ steel bar)

| Temperature | Formula B |
|---|---|
| 15° C. | 0.28 |
| 23° C. | 0.30 |
| 30° C. | 0.52 |
| 45° C. | 0.28 |
| 60° C. | 0.14 |

### Example 3

A damping layer formula and its ingredients can be found in Table 5 below.

TABLE 5

| Ingredient | Formula C |
|---|---|
| Bromobutyl (Exxon 2222) | 19.5% |
| Arbocel 185 | 12.0% |
| Wingtack 86 | 16.0% |
| Sylvatac RE-40 | 4.5% |
| Elvax 4310 | 4.0% |
| Escorene Ultra LD-720 | 4.0% |
| Aclyn 295 Ionomer | 4.0% |
| Indopol H-1500 | 11.5% |
| Mistron Vapor R | 24.0% |
| B22237 | 0.5% |

Peel adhesion strength at the time of cohesive failure was measured as 28.0 lbs/in at about 25° C. (±2° C.) using the ASTM D3330 test method by clamping the base blank portion of the damping system in a fixed position so as to lock the base blank portion in place and subsequently pulling the constraining layer portion upward at a rate of 12 inches per minute and measuring the force (lbs/in) once the base blank and constraining layer begin to separate.

The vibration damping performance of the composite was measured using the Oberst test (SAE J1637) as known in the art. The loss factor for the above-described damping system was interpolated at 200 Hz at the temperatures shown in table 6.

TABLE 6
Oberst Results (0.030″ steel bar/0.020″ mastic/0.030″ steel bar)

| Temperature | Formula C |
|---|---|
| 15° C. | 0.29 |
| 23° C. | 0.32 |
| 30° C. | 0.37 |
| 45° C. | 0.31 |
| 60° C. | 0.14 |

### Example 4

A damping layer formula and its ingredients can be found in Table 7 below.

TABLE 7

| Ingredient | Formula D |
|---|---|
| Chlorobutyl (Exxon 1066) | 19.5% |
| Arbocel 185 | 12.0% |
| Wingtack 86 | 16.0% |
| Sylvatac RE-40 | 4.5% |
| Elvax 4310 | 4.0% |
| Escorene Ultra LD-720 | 4.0% |
| Aclyn 295 Ionomer | 4.0% |
| Indopol H-1500 | 11.5% |
| #60 Dolomite | 24.0% |
| B22237 | 0.5% |

Peel adhesion strength at the time of cohesive failure was measured as 29.2 lbs/in at about 25° C. (±2° C.) using the ASTM D3330 test method by clamping the base blank portion of the damping system in a fixed position so as to lock the base blank portion in place and subsequently pulling the constraining layer portion upward at a rate of 12 inches per minute and measuring the force (lbs/in) once the base blank and constraining layer begin to separate.

The vibration damping performance of the composite was measured using the Oberst test (SAE J1637) as known in the art. The loss factor for the above-described damping system was interpolated at 200 Hz at the temperatures shown in table 8.

TABLE 8
Oberst Results (0.030″ steel bar/0.020″ mastic/0.030″ steel bar)

| Temperature | Formula D |
|---|---|
| 15° C. | 0.24 |
| 23° C. | 0.32 |
| 30° C. | 0.46 |
| 45° C. | 0.33 |
| 60° C. | 0.15 |

Although the preferred embodiments of the invention have been shown and described, it should be understood that various modifications and changes may be resorted to without departing from the scope of the invention as disclosed and claimed herein.

1. A damping composition for a vibrational damping layer comprising about 18 to about 40 weight percent butyl rubber and about 4 to about 12 weight percent ethylene copolymer.

2. The damping composition of claim 1, wherein the butyl rubber comprises a halogenated butyl rubber selected from the group consisting of chlorobutyl rubber and bromobutyl rubber.

3. The damping composition of claim 1, wherein the ethylene copolymer comprises one or more ethylene vinyl acetates.

4. The damping composition of claim 1, further comprising a plasticizer present at about 5 to about 20 weight percent.

5. The damping composition of claim 1, further comprising a filler present at about 10 to about 50 weight percent.

6. The damping composition of claim 1, further comprising a tackifier present at about 2 to about 30 weight percent.

7. The damping composition of claim 1, further comprising an adhesion promoter present at about 1 to about 10 weight percent.

8. The damping composition of claim 1, wherein the damping composition is substantially free of a curing agent.

9. The damping composition of claim 8, wherein the damping composition is substantially free of an acceleration agent.

10. The damping composition of claim 3, wherein one of the ethylene vinyl acetates is acid modified.

11. The damping composition of claim 3, wherein one of the ethylene vinyl acetates has a vinyl acetate loading between about 10 and about 40.

12. A damping composition for a vibrational damping layer comprising:
(i) about 18 to about 40 weight percent butyl rubber;
(ii) about 4 to about 12 weight percent of ethylene vinyl acetate;
(iii) about 10 to about 50 weight percent filler;
(iv) about 5 to about 20 weight percent plasticizer;
(v) about 2 to about 30 weight percent tackifier;
(vi) about 1 to about 10 weight percent adhesion promoter;
wherein the damping composition is substantially free of a curing agent.

13. A damping system comprising a base blank, a constraining layer, and a damping layer, wherein the damping layer comprises from about 18 to about 40 weight percent of a butyl rubber, and is in contact with and positioned in between the base blank and the constraining layer.

14. The damping system of claim 13 wherein the butyl rubber based comprises a halogenated butyl rubber selected from the group consisting of chlorobutyl rubber and bromobutyl rubber.

15. The damping system of claim 13, wherein the damping layer further comprises about 4 to 12 weight percent ethylene copolymer.

16. The damping system of claim 15, wherein the ethylene copolymer comprises one or more ethyl vinyl acetates.

17. The damping system of claim 13, wherein the damping layer exhibits a peel adhesion strength of greater than 10 lb in/in as measured at about 25° C. according to ASTM D3330.

18. The damping system of claim 13, wherein the damping layer exhibits a loss factor of at least 0.15 for a vibration of 200 Hz.

19. The damping system of claim 13, wherein the system is formed or stamped after the damping layer is in contact with and positioned between the base blank and the constraining layer.

20. The damping system of claim 19, wherein the damping layer remains substantially uncured.
